(19) United States
(12) Patent Application Publication
(10) Pub. No.: US 2003/0058089 A1
(43) Pub. Date: Mar. 27, 2003

(54) Display system for the internal tire pressure

(76) Inventors: Volker Ruehr, Stuttgart (DE); Michael Baum, Tiefenbronn-Lehningen (DE); Rolf Hofmann, Weil der Stadt (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/222,987

(22) Filed: Aug. 19, 2002

(30) Foreign Application Priority Data
Aug. 17, 2001 (DE) 101 40 436.0

(51) Int. Cl. B60C 23/00

(52) U.S. Cl. 340/442

(57) ABSTRACT

A display system for the internal tire pressure of tires of a vehicle. In order to display of pressure values for the driver so that the driver receives easily perceivable information concerning the internal tire pressure and its deviation, the driver receives an indication of the deviation between the actual internal tire pressure and the desired internal tire pressure.

### BACKGROUND AND SUMMARY OF THE INVENTION

This application claims the priority of German Application No. 101 40 436.0, filed Aug. 17, 2001, the disclosure of which is expressly incorporated by reference herein.

The invention relates to a display system for the internal pressure of tires of a vehicle.

Multiple methods are known for detecting the internal pressure of tires of a vehicle while the vehicle is either standing or in motion and to display them to the driver. It is also known to compare the measured internal tire pressure with a desired internal tire pressure by forming the difference and to generate a warning message to the driver of the vehicle as soon as the difference exceeds a given differential value—particularly in the sense of falling below the desired internal tire pressure.

Tire pressure sensors which consist of combined sensor and transmitting devices are used to determine the internal tire pressure. The tire pressure sensors are arranged on rims or on tires and transmit signals to receiving devices arranged on the body of the vehicle in the proximity of the wheels. It is thus possible to determine the wheel at which the tire pressure is measured and indicate to the driver which tire has an internal pressure which deviates from the desired value. Furthermore, the transmitting devices are normally provided with an identifier generator, so that, in addition, a tire change can be recognized.

The display of the actual internal tire pressure or of the desired internal tire pressure generally takes the form of an absolute pressure value.

It is an object of the invention to design the display of pressure values to the driver so that the driver receives easily perceivable information concerning the internal tire pressure and its deviation.

According to the invention, a driver display indicates a deviation of the internal tire pressure as a difference between the actual internal tire pressure and the desired internal tire pressure. As a result of these measures, when putting air in a tire, the driver only has to remember the differential value, whereas up to now, there was the risk that, particularly in the case of tires which differ in the front and the rear, he may confuse the information concerning the desired internal tire pressures. Furthermore, the precision as a whole of the adjustment of the actual internal tire pressure is increased. Customary air filling devices, as found, for example, in gas stations, have a noticeable error when indicating the absolute value for the measured actual internal tire pressure, so that, also in the case of a precise adjustment of the actual internal tire pressure according to the indication of the filling device, this error may occur in the case of the actual internal tire pressure. In contrast, the display of a differential value takes place much more precisely, so that also the precision during the adjustment of the actual internal tire pressure is improved by means of the filling device.

Also, according to the invention, the display device is supplemented by at least one sensor for the temperature in the tire in order to compensate the desired internal tire pressure for the temperature value of the tire. With this arrangement, the differential pressure display has the special advantage that the driver will not be confused by different temperature-dependent absolute values of the desired internal tire pressure but instead receives the neutral information from the display device as to how much he should change the interior tire pressure. As a result, it will be impossible for the driver to accidentally set an internal tire pressure which he may still remember from a preceding filling operating but which has now become invalid because of different temperatures.

Furthermore, the invention provides a memory for storing different desired internal-tire pressures. The selection of the desired internal tire pressure from this memory should preferably take place such that first the type of tire (summer tire/all-weather tire/winter tire/cross-country tire/emergency wheel) is chosen and subsequently the tire size is selected. In addition, the selection of the desired internal tire pressure, the loading condition (partially loaded/fully loaded) and the operating mode (road, hard terrain/soft terrain) may be provided. The use of these data simplifies the selection of the applicable desired internal tire pressure because the driver does not have to know the precise designation of the tire but must only know the purpose of the tire.

Finally, it is an advantage for sufficient free space to be provided in this memory for use by the driver or the shop, in which desired internal tire pressures for tires to be mounted on the vehicle, can be freely recorded, for example, by means of a special permit or for competition purposes without a permit.

Other objects, advantages and novel features of the present invention will become apparent from the following detailed description of the invention when considered in conjunction with the accompanying drawings.

### BRIEF DESCRIPTION OF THE DRAWINGS

The invention will be explained in detail by means of the embodiment illustrated in the figures.

FIG. 1 is a diagrammatic overview of the display device;

FIG. 2 is a diagram of the operation of an analyzing device;

FIG. 3 illustrates an example of a display of a pressure difference; and

FIG. 4 shows an example of a tire selection.

### DETAILED DESCRIPTION OF THE PREFERENCE EMBODIMENT

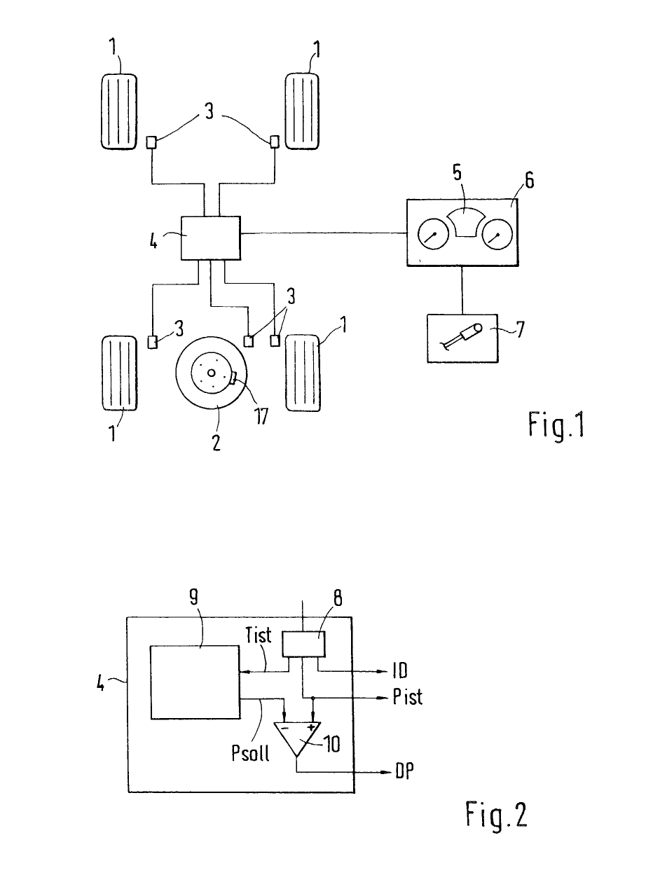

The overview according to FIG. 1 shows four wheels 1 as well as a spare wheel 2 of a motor vehicle which is not shown in detail. A transmitter 17 is arranged in each wheel 1 as well as in the spare wheel 2 respectively (here, only shown at the spare wheel 2). Receivers 3 are arranged in the proximity of the wheels 1 or of the spare wheel 2 such that the signals of the pertaining transmitters 17 can be received. The receiver of the spare wheel 2 may be eliminated if the signal of the transmitter in the spare wheel 2 can also be received by other receivers 3. The signals of the receivers 3 are fed as sensor signals into an analyzing device 4 which, in turn, is connected with a display device, here illustrated as a videoscreen 5 in an instrument cluster 6. For operating the instrument cluster, and particularly for the influencing and selection of the display on the video screen 5, the instrument cluster 6 is connected with a steering column switch 7.

FIG. 2 is a diagrammatic view of the analyzing device 4. In an input stage 8, the signals of each receiver 17 are decoded such that, for each wheel 1 or the spare wheel 2, the values for the actual temperature Tist (Tactual), the actual internal tire pressure Pist (Pactual) and the transmitter identification ID are decoded. For the purpose of clarity, FIG. 2 shows only the analysis for a single wheel 1; this analysis takes place analogously for each wheel 1 and the spare wheel 2.

The transmitter identification ID is analyzed in the analyzing device 4 to determine whether a wheel change has taken place. When a wheel change is detected, the driver is requested by a corresponding display (see FIG. 5) on the video screen 5 to supply information about the actual tires. If the transmitter identification ID is assigned not only to one rim of the wheel 1 but, for example, is assigned to the tire by a transmitter 17 vulcanized directly into a tire of the wheel 1, it is also possible to use the transmitter identification ID for the automatic selection of tire parameters from a memory 9. Finally, it is also possible that such a transmitter identification ID contains direct information with respect to desired internal tire pressures which otherwise would have to be made available in the memory 9.

Desired internal tire pressures Psoll (Pdesired) for various tire parameters and operating parameters are stored in the memory 9. The desired internal tire pressures Psoll are either filed for different temperatures Tist in the memory 9, or a correction algorithm is provided for the compensation of the influence of the temperature Tist on the desired internal tire pressure Psoll. In each case, the actually valid desired internal tire pressure Psoll is selected as a function of the actual temperature Tist in the respective wheel 1 or spare wheel 2 and is supplied to a difference forming device 10, where a difference DP is formed between the desired internal tire pressure Psoll and the actual internal tire pressure Pist. The difference DP is transmitted to the instrument cluster 6 and is displayed on the videoscreen 5.

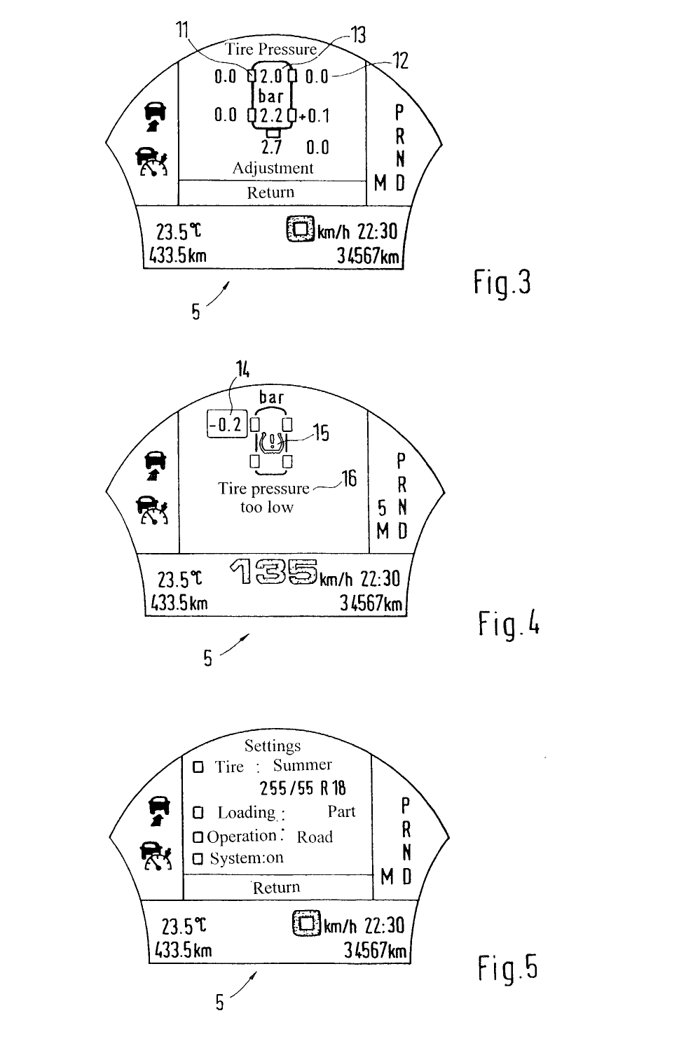

An example of a display of a difference DP on the videoscreen 5 is illustrated in FIG. 3. Five wheel positions 11 are provided in a schematic representation of the vehicle. Next to each wheel position 11, the values 12 of the difference DP are indicated for this wheel position. In addition, in this embodiment, values 13 are also indicated for the temperature-compensated desired internal tire pressure Psoll.

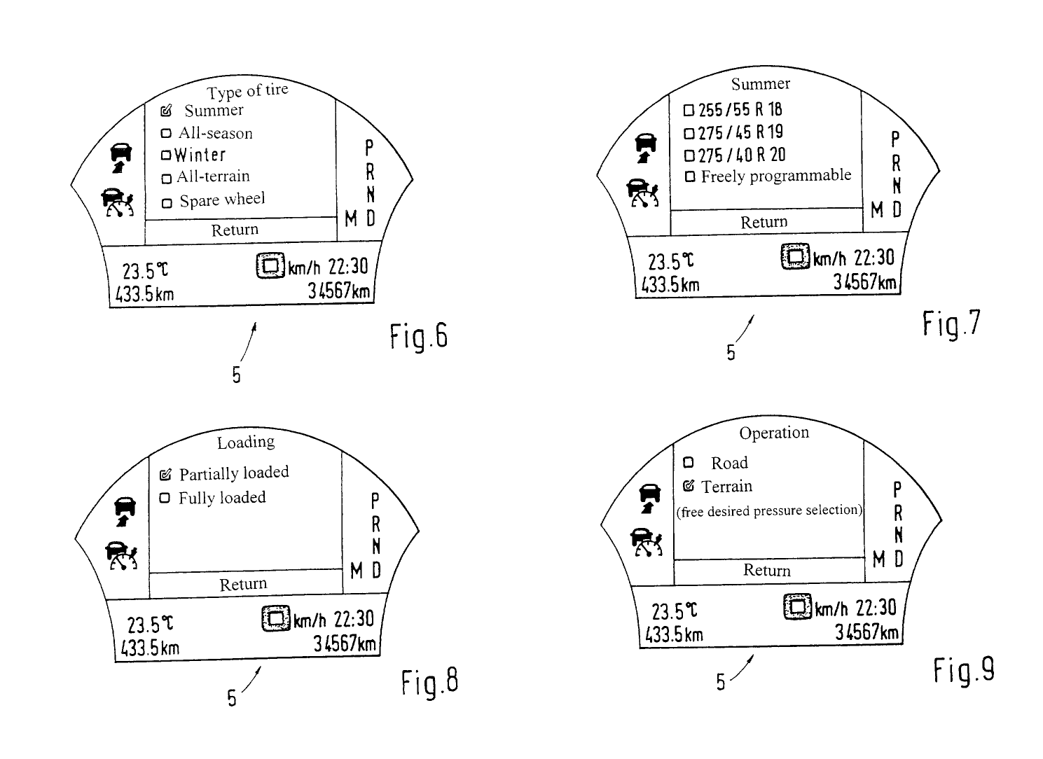

FIG. 4 shows a display of a difference DP on the video screen 5 when the difference DP has fallen below a defined value; that is, the actual internal tire pressure Pist is too low. Here, the value 14 of the difference DP together with a warning message (warning symbol 15 and text 16 “tire pressure too low”) is indicated only at the wheel position at which this value was determined. In contrast to the display according to FIG. 3, the display according to FIG. 4 also takes place while driving.

The selection of the desired internal tire pressure Psoll in the memory 9 takes place by means of the video screen 5 and of the steering column switch 7. In the display according to FIG. 3, the “settings” point is selected by means of the steering column switch 7, to provide the display according to FIG. 5. Here, the tire parameters “type of tire”, “tire size”, “loading” and “operation” are displayed and can be selected by means of the steering column switch 7. The tire parameter “type of tire” can be selected, for example, from the values, summer, all-season, winter, all-terrain and spare wheel (see FIG. 6). The tire parameter “tire size” can subsequently be selected from the values permitted for the respective type of tire (see FIG. 7). For each type of tire, a memory location is provided in the memory 9, which location is not occupied by a tire value, in order to be able to record tires for competition purposes or with special permits. The recording in the memory 9 takes place by means of a diagnostic instrument in a shop.

Subsequently, the operating parameters “loading condition” are partially loaded and fully loaded with the possible values (see FIG. 8) and “operating mode” is selected from the possible values road and terrain (see FIG. 9). In addition, a differentiation could be made here between an operation on hard and soft terrain.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A system for monitoring internal tire pressure (Pist) of at least one tire of a vehicle, said system comprising:
at least one sensor for provide the actual internal tire pressure (Pist);
a memory including a desired internal tire pressure (Psoll);
a difference forming device for forming the difference (DP) between the actual internal tire pressure (Pist) and the desired internal tire pressure (Psoll); and
a display device for displaying a value of the difference (DP).

2. The system according to claim 1, wherein at least one of said at least one sensor is provided for measuring the temperature (Tist) in one of said at least one tire and a computing device is provided for the compensation of the desired internal tire pressure (Psoll) as a function of the temperature (Tist) before the transmission to the difference forming device.

3. The system according to claim 1, wherein the desired internal tire pressures (Psoll) for different tire and operating parameters are stored in said memory, and said display device further displays the tire and operating parameters, and a selection device is provided for the selection of the tire and operating parameters.

4. The system according to claim 3, wherein said memory includes free memory locations.

5. A tire pressure compensation system, comprising:
at least one pressure sensor for providing an internal tire pressure signal;
at least one temperature sensor for provides an internal tire temperature signal;
calibrating means for modifying said internal tire pressure signal as a function of said tire temperature signal and outputting a modified signal.

6. The system according to claim 5 further including:
a memory for storing a desired internal tire pressure;
a different forming device for forming the difference between said desired internal tire pressure and a value of said modified signal; and
a display device for displaying said difference.

7. The system according to claim 5, wherein the desired internal tire pressures (Psoll) for different tire and operating parameters are stored in said memory, and said display device further displays the tire and operating parameters, and a selection device is provided for the selection of the tire and operating parameters.
